(19) United States
(12) Patent Application Publication
(10) Pub. No.: US 2008/0094541 A1
(43) Pub. Date: Apr. 24, 2008

(54) COLOR SEQUENTIAL LIQUID CRYSTAL DISPLAY

(75) Inventors: Mei-sheng Ma, Hsin-Chu City (TW); Hsueh-ying Huang, Hsin-Chu City (TW)

Correspondence Address: MADSON & AUSTIN, 15 WEST SOUTH TEMPLE, SUITE 900, SALT LAKE CITY, UT, 84101, US

(73) Assignee: AU Optronics Corp., Hsin-Chu (TW)

(21) Appl. No.: 11/780,320

(22) Filed: Jul. 19, 2007

(30) Foreign Application Priority Data
Oct. 24, 2006 (TW) 095139231

(51) Int. Cl. G02F 1/13357; F21S 2/00

(52) U.S. Cl. 349/69; 362/231

(57) ABSTRACT

A color sequential LCD display is disclosed. In addition to three base color lights including red, green and blue, the display also utilizes at least one additional color light whose color space coordinate is different from any of the three base color lights as additional light source for backlight. By doing so, and objective of expanding gamut ratio of the display can be achieved.

### TECHNICAL FIELD OF THE INVENTION

The present invention relates to a liquid crystal display (LCD), and more particularly, to a color sequential LCD which is capable of effectively expanding color gamut.

### BACKGROUND OF THE INVENTION

A conventional thin film transistor liquid crystal display (TFT-LCD) utilizes a white backlight and color filters of red, green, and blue (RGB) to achieve an effect of color display. A color sequential liquid crystal display utilizes three color light sources of red, green and blue sequentially illuminating in a frame rather than using color filters. The three color lights of red, green, and blue are mixed through a color addition method to make color display by using persistence of vision effect of human eyes.

Generally, a liquid crystal display includes a liquid crystal display panel and a backlight module. The liquid crystal display (LCD) panel includes an upper substrate, a lower substrate, and a liquid crystal layer placed therebetween. A number of pixels constructing an array are provided on one of the upper and lower substrates. Upper and lower electrodes corresponding to each pixel are provided on the substrate. The backlight module includes RGB light sources for providing color lights used in sequential color mixing. Data signals are fed to the LCD panel in a sequence of RGB. The backlight model executes turning on/off operation to the color light sources according to the data fed to the LCD panel. Display signals fed to the LCD panel are converted into pixel electrode voltages to control the behavior of the liquid crystal. By controlling light intensity of the backlight penetrating the pixels, ratio of the respective color lights illuminated by the backlight module is adjusted so as to mix the lights into different shading levels (i.e., gray levels).

Each of the R, G, B backlights has a specific main wavelength and a coordinate in the chroma space. The region defined by the three coordinates of the three color lights is a color gamut, that is, the color range that the LCD can display.

In view of color displaying, the broader the gamut of the LCD is, the more powerful the color displaying capability of the LCD is. For the conventional sequential LCD, the range defined by the color coordinates of RGB backlights is limited. It will be a significant improvement if the color gamut of the LCD can be effectively expanded.

Accordingly, there is a need to provide a novel color sequential LCD, which can effectively expand the color gamut of color displaying.

### SUMMARY OF THE INVENTION

One aspect of the present invention is directed to a color sequential LCD, which is able to effectively expand the color gamut of color displaying thereof.

In accordance with the present invention, the color sequential LCD comprises an LCD panel, which has an upper substrate and a lower substrate, as well as liquid crystal sandwiched therebetween. The upper or lower substrate has circuitry and a pixel array. Each pixel has an upper electrode and a lower electrode. Transmittance of the liquid crystal is controlled by controlling a voltage across the upper and lower electrodes. The LCD panel applies different voltages to control the light intensity through the liquid crystal according to image data signals. The color sequential LCD further comprises a LED backlight device providing backlight to the LCD panel for displaying colors. The LED backlight device has three light sources emitting three base color lights and at least one additional light source emitting an additional color light. The coordinate of the additional color light is different to those of the three base color lights. The base color light sources and the additional color light source are turned on/off respectively to emit color lights in a predetermined sequence by using a sub-frame, which is divided from a frame, as a unit. The intensities of the three base color lights and the additional color light are adjusted to achieve white balance. The color sequential LCD still comprises a conversion device for converting incoming image data into data signals composed by the color lights, and an image data control device for controlling timings and intervals of each frame and each sub-frame for the backlight device, and synchronously sending scan signals and converted data signals to the LCD panel in correspondence to the ON/OFF statuses of the respective color lights. According to the image data, voltages are sequentially applied to the pixel electrodes of the LCD panel in sub-frames for different color lights to adjust the transmittance of the liquid crystal. By controlling light intensity through each pixel, the pixel can appear a correct gray scale, and therefore a pattern is formed by the pixel array.

Another aspect of the present invention is directed to a light emitting diode (LED) backlight device. The LED backlight device comprises three base light sources for respectively emitting three base color lights, and an additional light source for emitting an additional color light of which the color coordinate is different from the color coordinate of any of the three base color lights.

Still another aspect of the present invention is directed to a displaying method for a color sequential liquid crystal display. The method comprises providing backlight for an LCD panel to display an image. The backlight comprises three base color lights and an additional color light, the color coordinate of the additional color light being different from the color coordinate of any of the three base color lights. The base color lights and the additional color light are turned on and off to emit lights according to a predetermined sequence by a unit of a sub-frame which is divided from a frame. The method further comprises controlling timing and interval of each frame and each sub-frame and synchronously inputting corresponding scan signal and data signal to the LCD panel in coordination with on/off of the respective color lights, and controlling to sequentially apply voltages to pixel electrodes of the LCD panel in the sub-frames for different color lights.

### BRIEF DESCRIPTION OF THE DRAWINGS

FIG. 1 schematically shows a color sequential LCD in accordance with one embodiment of the present invention;

FIG. 2 shows a structure of a sidelight type backlight module;

FIG. 3 shows a timing diagram of ON/OFF statuses of the respective color lights in sub-frames of a frame in accordance with an embodiment of the present invention; and

FIG. 4 shows color gamut ranges achieved by the conventional color sequential LCD displaying method and the method of the present invention, respectively.

### DETAILED DESCRIPTION OF THE INVENTION

The present invention will be further described in details in conjunction with the accompanying drawings.

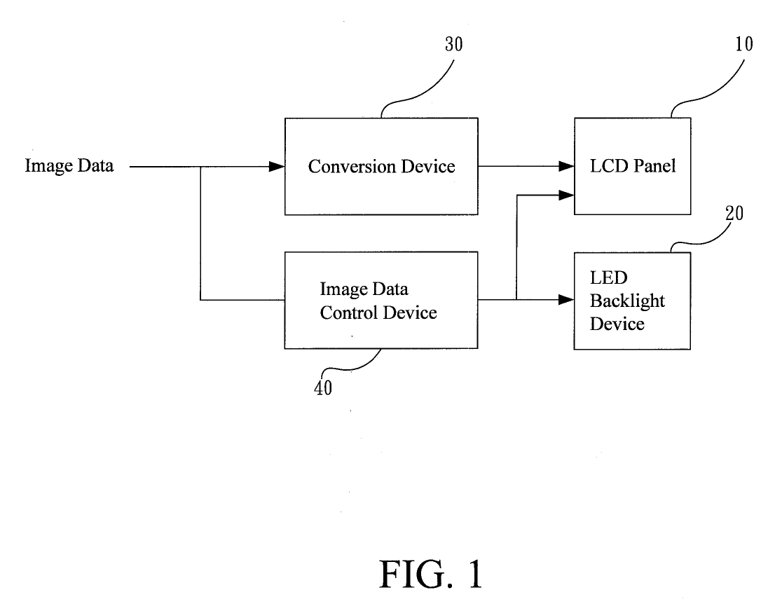

FIG. 1 schematically shows a color sequential LCD in accordance with one embodiment of the present invention. As shown, the color sequential LCD comprises an LCD panel 10, an LED backlight device 20, a conversion device 30 and an image data control device 40. The details will be described as follows.

The LCD panel 10 has an upper substrate and a lower substrate. A pixel array composed of a plurality of pixel electrodes is provided on one of the upper and lower substrates. Liquid crystal is disposed between the upper and lower substrates.

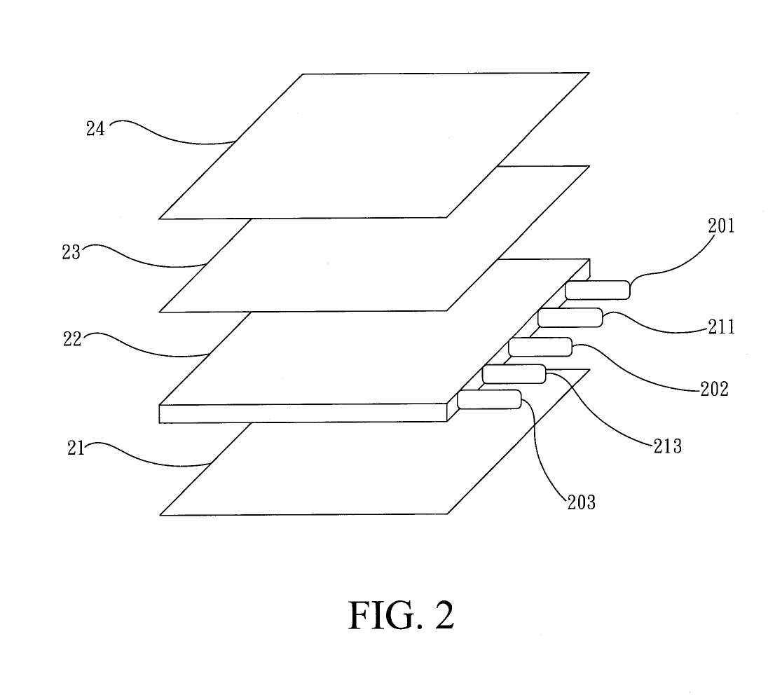

In accordance with an embodiment of the present invention, the LED backlight device 20 can be implemented by a sidelight type backlight module, of which the basic structure is shown in FIG. 2. The backlight device 20 comprises a plurality of light sources 201, 202, 203, 211, 213, the details will be further described later. The backlight device 20 further has a reflective plate 21 for reflecting incident light toward the upper direction, a light-guide plate 22 for spreading the incident light over the whole light-guide plate through multiple refractions and reflections to form a plane light source, a diffusion plate 23 for further spreading light illuminated from the light-guide plate over the whole surface more uniformly, so as to achieve uniform light output, and a prism plate 24 for receiving incident light beams of different directions and outputting emergent light in the upper direction through refractions and reflections.

In addition to three base light sources 201, 202, 203 of red (R), green (G), blue (B) lights, the backlight device 20 has additional light sources 211 and 213. In the present embodiment, the additional light sources 211 and 213 are another red light source and another blue light source with main wavelengths different from the base red and blue light sources, respectively. That is, the LED backlight device 20 of the present embodiment has five light sources. The five light sources are R1, R2 light sources 201, 211 with different main wavelengths, G light source 202, and B1, B2 light sources 203, 213 with different main wavelengths. It is noted that although the additional red light source and blue light source, which are of the same colors but having different main wavelengths with the base color lights, are used as the additional light sources, the choice for the additional light sources is not limited thereto. Here, the definition of “same color” is similar to general chromatics. For example, a light source of a color other than the three base colors can be used, such as a cyan light source or a yellow (Y) light source. Further, a color light which has a main wavelength the same as that of one of the base lights but has a color coordinate in the color space different from said base light can also be used. In addition, the number of the additional light sources is not limited. In the present embodiment, two additional color light sources are used. However, one or more than two additional color light sources are also possible as required. White balance generally made by RGB color lights should be achieved by five color lights of R1, R2, G, B1 B2, for example.

As described above, the color sequential LCD in accordance with the present invention further has the conversion device 30. Externally inputting image data is set based on R, G, B. However, the light sources have increased to include R1, R2, G, B1, B2. Data signals fed to the LCD panel are also decomposed into R1, R2, G, B1, B2. Accordingly, in the present embodiment, the conversion device 30 converts the image data, adjusts the voltage applied to the liquid crystal by the pixel electrode for each color light so as to control the light intensity passing through the liquid crystal. Thus, correct color tones and gray scales can be displayed.

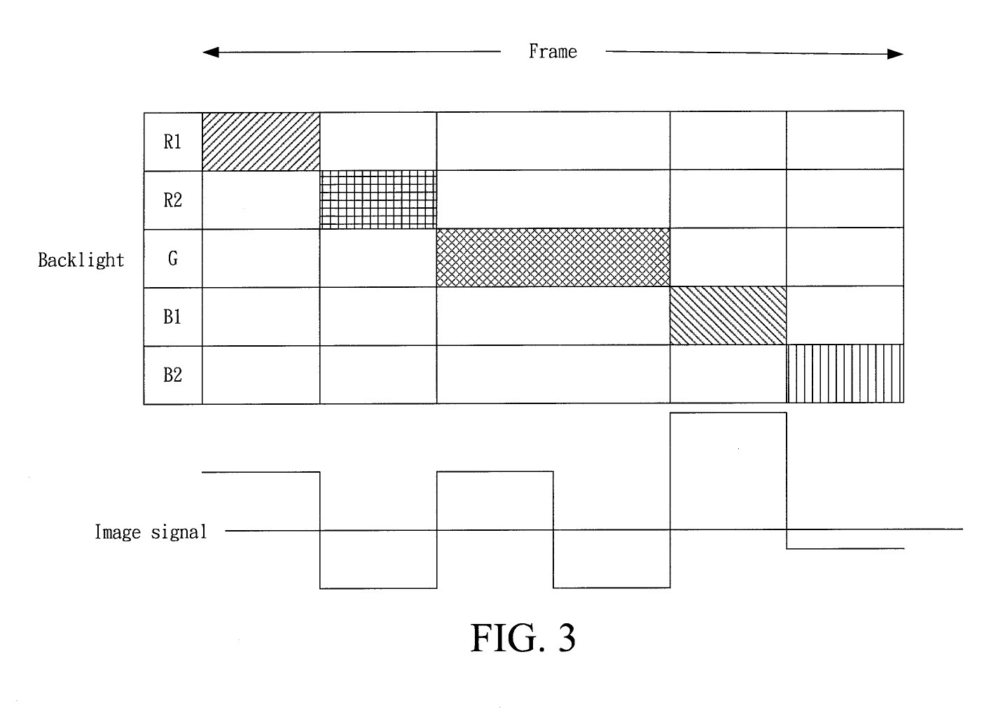

Under the control of the image data control device 40, the respective light sources in the backlight device 20 of the color sequential LCD emit lights in sequence to achieve an effect of color display. A specific ratio of the light intensities of the respective color lights is obtained by adjusting the light transmittance of the liquid crystal. In the present embodiment, one frame is divided into six sub-frames. The R1 light source emits light during the interval of the first sub-frame; the R2 light source emits light during the interval of the second sub-frame; the G light source emits light during the intervals of the third and fourth sub-frames; the B1 light source emits light during the interval of the fifth sub-frame; the B2 light source emits light during the interval of the sixth sub-frame, as shown in FIG. 3. In this case, the intervals of the respective sub-frames are the same. As described, the concept of the same color is similar to the that of chromatics. In the present embodiment, the timing for the light sources emit lights according to the sequence of R1, R2, G, G, B1, B2. That is, color light sources emitting color lights of the same color but with different wavelengths are turned on/off in succession. For example, R1 and R2 light sources successively emit light. When each color light source emits light, the pixels of the LCD panel 10 are fed with corresponding data signals synchronously, so that the liquid crystal appears a predetermined transmittance to control the mixing ratio of the respective color lights, thereby an image can be correctly displayed. The above five colors are basic colors for constructing a single pattern. Other arrangements are also possible. For example, in the condition that the single frame is divided into six sub-frames, the sequence of emitting lights can be R1, G, B1, R2, G, Bs, or R1, B1, R2, B2, G, G or B1, R2, B2, G, R1, G or the like. In another case, one frame is divided into three sub-frames, and emitting of the color light sources R1, G, B1, R2, G, B2 emit lights in any proper sequence is completed in two frames. For example, R1, G, B1 light sources are turned on in the first frame, while R2, G, B2 light sources are turned on in the second frame. The division of the sub-frames can be arranged as required. The LED backlight device 20 emits the color lights according to any determined sequence. That is, it is not necessary to follow a specific light emitting sequence. Preferably, the respective sub-frames of one frame occupy the equal time period, so that control is easy to be done. However, it is also possible that the respective sub-frames occupy different time periods. Intervals and frequencies of the sub-frame and sub-frames are controlled by the image data control device 40.

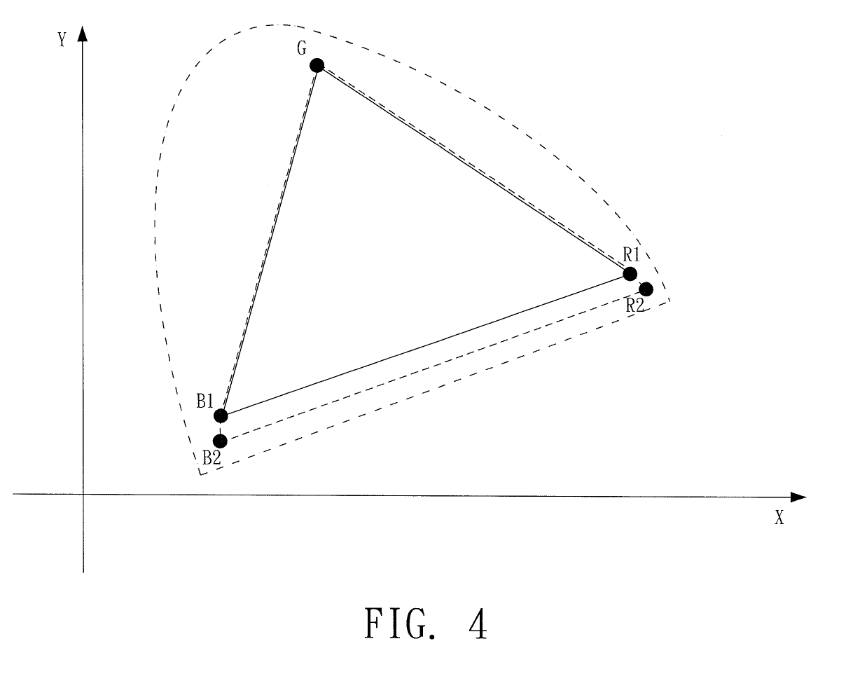

In the present embodiment, the R1 color light has the main wavelength of 610 nm, the CIE colorimetric value (i.e. color coordinate) thereof is (0.664, 0.336); the R2 color light has the main wavelength of 630 nm, the color coordinate thereof is (0.685, 0.315); the G color light has the main wavelength of 525 nm, the color coordinate thereof is (0.166, 0.735); the B1 color light has the main wavelength of 470 nm, the color coordinate thereof is (0.124, 0.075); the B2 color light has the main wavelength of 455 nm, the color coordinate thereof is (0.148, 0.040). Referring to FIG. 4, the color gamut of the LCD indicated by the triangle range circumscribed by the real lines is 109.1% when only three color lights including R1, G, B1 are used. The color gamut of the LCD indicated by the pentagon range circumscribed by the dotted lines is up to 115.2% when five color lights including R1, R2, G, B1, B2 are used.

In the present embodiment, additional color lights having the different main wavelengths with the three base color lights are used to expand the gamut. However, as described, even the color lights having the same main wavelengths as the base color lights can also be used. There is a phenomenon called “metamerism” in chromatics. Color lights of the same color have the same main wavelength but different spectrums, results in the color coordinates thereof are different. For example, two red lights both have the main wavelength of 615 mm. However, due to different spectrums, the color coordinates of the two red lights are respectively (0.6207, 0.3204) and (0.6278, 0.3204). If one of these two red lights is used as one of the three base color lights, then the other red light can be used as the additional color light. It is noted that no matter the additional color light has the same or different wavelength with the base color lights, the color coordinate thereof should be different to that of any of the three base color lights. In addition, the color coordinate of the additional color light should fall outside the gamut range defined by the three base color lights in the color space to expand the color gamut.

While the preferred embodiments of the present invention have been illustrated and described in details, various modifications and alterations can be made by persons skilled in this art. The embodiments of the present invention are therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A color sequential liquid crystal display comprising:
a liquid crystal display (LCD) panel having liquid crystal and a pixel array for controlling the liquid crystal transmittance by applying voltages;
a backlight device having three base color light sources for emitting three base color lights and an additional light source for emitting an additional color light, the additional color light having a color coordinate which is different from color coordinates of the three base color lights, the base color light source and the additional light source being turned on and off to emit color lights according to a predetermined sequence; and
an image data control device for controlling the backlight device according to timings and intervals of each frame and each sub-frame, and synchronously transmitting corresponding scanning signal and data signal to the LCD panel in coordination with on/off of the respective color light sources.

2. The color sequential liquid crystal display as claimed in claim 1, wherein the color coordinate of the additional color light falls outside a color gamut defined by the color coordinates of the three base color lights.

3. The color sequential liquid crystal display as claimed in claim 1, wherein the three base color lights are red (R), green (G), and blue (B) color lights.

4. The color sequential liquid crystal display as claimed in claim 1, wherein the main wavelength of the additional color light is different from the main wavelength of any of the three base color lights.

5. The color sequential liquid crystal display as claimed in claim 1, wherein the main wavelength of the additional color light is the same as the main wavelength of one of the three base color lights.

6. The color sequential liquid crystal display as claimed in claim 1, wherein the sequence for the color light sources to emit the color lights is to emit the base color light and the additional color light of the same color in succession.

7. The color sequential liquid crystal display as claimed in claim 1, wherein the sequence for the color light sources to emit the color lights is to emit the base color light and the additional color light of the same color at spaced intervals.

8. A light emitting diode (LED) backlight device comprising:
three base light sources for respectively emitting three base color lights; and
an additional light source for emitting an additional color light of which the color coordinate is different from the color coordinate of any of the three base color lights.

9. The LED backlight device as claimed in claim 8, further comprising:
a reflective plate for reflecting incident lights toward a predetermined direction; a light-guide plate for spreading the incident lights over the whole light-guide plate guiding the lights toward the predetermined direction;
a diffusion plate for spreading lights illuminated from the light-guide plate over the whole surface more uniformly, so as to achieve uniform light output; and
a prism plate for receiving incident light beams of different directions from the diffusion plate and outputting emergent lights in the predetermined direction.

10. The LED backlight device as claimed in claim 8, wherein the color coordinate of the additional color light falls outside a color gamut defined by the color coordinates of the three base color lights.

11. The LED backlight device as claimed in claim 8, wherein the three base color lights are red (R), green (G) and blue (B) color lights.

12. The LED backlight device as claimed in claim 8, wherein the main wavelength of the additional color light is different to the main wavelength of any of the three base color lights.

13. The LED backlight device as claimed in claim 8, wherein the main wavelength of the additional color light is the same as the main wavelength of one of the three base color lights.

14. A displaying method for a color sequential liquid crystal display, said color sequential liquid crystal display comprising a liquid crystal display (LCD) panel, which has liquid crystal and a pixel array for applying a voltage to control the transmittance of the liquid crystal, said panel applying different voltages to the LCD panel pixels to control the light intensity of backlight passing through the liquid crystal according to data signals, said method comprising:
providing backlight for the LCD panel to display an image, the backlight comprising three base color lights and an additional color light, the color coordinate of the additional color light being different from the color coordinate of any of the three base color lights, the base color lights and the additional color light being turned on and off to emit lights according to a predetermined sequence by a unit of a sub-frame which is divided from a frame;
controlling timing and interval of each frame and each sub-frame and synchronously inputting corresponding scan signal and data signal to the LCD panel in coordination with on/off of the respective color lights; and
controlling to sequentially apply voltages to pixel electrodes of the LCD panel in the sub-frames for different color lights.

15. The method as claimed in claim 14, wherein the color coordinate of the additional color light falls outside a color gamut defined by the color coordinates of the three base color lights.

16. The method as claimed in claim 14, wherein the three base color lights are red (R), green (G) and blue (B) color lights.

17. The method as claimed in claim 14, wherein the main wavelength of the additional color light is different from the main wavelength of any of the three base color lights.

18. The method as claimed in claim 14, wherein the main wavelength of the additional color light is the same as the main wavelength of one of the three base color lights.

19. The method as claimed in claim 14, wherein the sequence for emitting the color lights is to emit the base color light and the additional color light of the same color in succession.

20. The method as claimed in claim 14, wherein the sequence for emitting the color lights is to emit the base color light and the additional color light of the same color at spaced intervals.
